(19) United States
(12) Patent Application Publication
(10) Pub. No.: US 2026/0236619 A1
(43) Pub. Date: Aug. 13, 2026

(54) Role-Aware Release-State Governance for Operationalized AI Outputs

(71) Applicant: KOJI MOCHIZUKI, Suita (JP)

(72) Inventor: KOJI MOCHIZUKI, Suita (JP)

(21) Appl. No.: 19/647,790

(22) Filed: Apr. 14, 2026

(30) Foreign Application Priority Data
Dec. 30, 2025 (JP) 2025-285315
Jan. 2, 2026 (JP) 2026-000019
Jan. 6, 2026 (JP) 2026-000645
Feb. 5, 2026 (JP) 2026-018084

(51) Int. Cl. G06F 21/64; G06F 30/33

(52) U.S. Cl. CPC G06F 21/64; G06F 30/33

(57) ABSTRACT

An operationalized AI output generated by an artificial-intelligence processing component is received before downstream operational commitment. A role-aware governance descriptor is determined based on recipient role, review purpose, audit purpose, and governing conditions comprising risk information, contextual information, a policy constraint, a boundary condition, an authority constraint, or a responsibility constraint. An intervention level, a release state, and an explanation depth are selected. An execution authority holder, a review authority holder, and at least one responsible entity are independently assigned. A role-specific human-readable rendering and a machine-readable release-control artifact bound to the operationalized AI output are generated. One or more downstream interfaces are gated according to validation of the release-control artifact so that the operationalized AI output is selectively set to direct release, confirmation-required release, review-only release, audit-only release, restricted release, or inhibited release.

### CROSS-REFERENCE TO RELATED APPLICATIONS

This application claims priority under 35 U.S.C. 119(a) to Japanese Patent Application No. 2025-285315, filed Dec. 30, 2025; Japanese Patent Application No. 2026-000019, filed Jan. 2, 2026; Japanese Patent Application No. 2026-000645, filed Jan. 6, 2026; and Japanese Patent Application No. 2026-018084, filed Feb. 5, 2026. The disclosures of these applications are incorporated herein by reference to the extent permitted by applicable law.

### FIELD OF THE INVENTION

The present invention relates to governance of artificial-intelligence-assisted information processing. More particularly, the invention relates to role-aware release-state governance for operationalized AI outputs after generation and before downstream operational commitment, including release-state selection, intervention-level selection, explanation-depth selection, authority separation, responsibility allocation, machine-readable release-control artifact generation, downstream interface gating, and revocation or update handling.

### BACKGROUND OF THE INVENTION

Artificial-intelligence-assisted systems increasingly generate outputs that are consumed by enterprise workflows, software-development pipelines, cloud and infrastructure operations, engineering tools, healthcare-support systems, financial-support systems, and other operational environments. In many such environments, an AI-generated output is not merely displayed; rather, the output may be reviewed, approved, executed, routed into a workflow, submitted for audit, exported, or used as a basis for downstream action.

Conventional systems often emphasize confidence scoring, explanation generation, personalized explanation formatting, approval workflow management, generic policy engines, compliance checks, or audit logging. These approaches are frequently fragmented. They may improve presentation, logging, or workflow administration, but they do not center technical control on a release state of a specific operationalized AI output and do not enforce such control through a machine-readable artifact bound to that same output.

In practical deployments, the core operational question is often not whether an AI output exists, but whether the output should be directly released, confirmation-required, review-only, audit-only, restricted, or inhibited. The answer may depend on recipient role, review purpose, audit purpose, risk, contextual conditions, policy constraints, boundary conditions, authority constraints, responsibility constraints, or business criticality. Further, execution authority and review authority are frequently not identical, and responsibility for approval, execution, review, and audit may need to be separately tracked.

Generic policy engines, generic approval workflows, generic audit logs, and generic explainability layers do not inherently provide output-bound release-state governance. Likewise, systems centered on exploration-phase defer control, safe exploration, judgment-placement umbrella architectures, restoration or continuation control, reevaluation priority, role reconfiguration, minimal-state restoration, or selective resume solve different problems. There remains a need for a post-output technical architecture that governs an operationalized AI output through a role-aware governance descriptor, a release-state selection, a machine-readable release-control artifact, and downstream interface gating.

### SUMMARY OF THE INVENTION

The present invention provides a system, method, and program for role-aware release-state governance of operationalized AI outputs. An operationalized AI output is received after generation and before downstream operational commitment. A role-aware governance descriptor is determined for the output based on recipient role, review purpose, audit purpose, and one or more governing conditions including risk, context, policy, boundary, authority-constraint, or responsibility-constraint conditions.

According to the governance descriptor, the system selects an intervention level, a release state, and an explanation depth. The system then independently assigns an execution authority holder, a review authority holder, and at least one responsible entity. A role-specific human-readable rendering and a machine-readable release-control artifact bound to the same operationalized AI output are generated.

The release-control artifact is then validated and used to gate one or more downstream interfaces so that the operationalized AI output is selectively set to direct release, confirmation-required release, review-only release, audit-only release, restricted release, or inhibited release. In some embodiments, the artifact includes signed or integrity-protected release-state metadata. In some embodiments, the artifact is updated, downgraded, reissued, or revoked when governing conditions change.

The invention therefore provides an output-bound governance layer that is neither limited to explanation display nor reducible to a generic approval workflow or policy engine. Instead, the same output is governed through a human-readable rendering, a machine-readable release-control artifact, and interface gating, thereby improving operational safety, auditability, technical accountability, and commercialization value of AI-assisted systems.

### BRIEF DESCRIPTION OF THE DRAWINGS

FIG. 1 is a functional block diagram of an example system for role-aware release-state governance of operationalized AI outputs.

FIG. 2 is a flowchart illustrating an example method for receiving an operationalized AI output, determining a role-aware governance descriptor, selecting an intervention level, selecting a release state, selecting an explanation depth, assigning authority and responsibility, generating a role-specific rendering and a release-control artifact, validating the artifact, and gating downstream interfaces.

FIG. 3 is a conceptual diagram illustrating an example release-state set and corresponding downstream interface conditions.

FIG. 4 is a conceptual diagram illustrating separation of execution authority, review authority, responsibility subject, role-specific renderings, and a machine-readable release-control artifact for a same operationalized AI output.

### DETAILED DESCRIPTION OF THE INVENTION

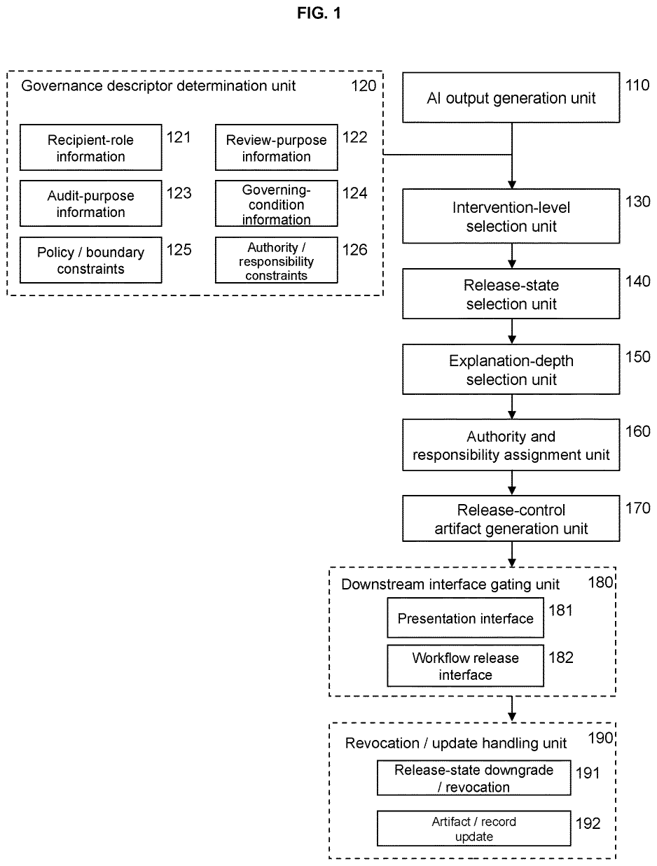

### 1. System Overview (FIG. 1)

An example system includes an AI output generation unit 110, a governance descriptor determination unit 120, an intervention-level selection unit 130, a release-state selection unit 140, an explanation-depth selection unit 150, an authority and responsibility assignment unit 160, a release-control artifact generation unit 170, a downstream interface gating unit 180, and a revocation/update handling unit 190. The governance descriptor determination unit 120 receives at least one of recipient-role information 121, review-purpose information 122, audit-purpose information 123, and governing-condition information 124. Governing-condition information 124 may include at least one of risk conditions, contextual conditions, policy constraints, boundary conditions, authority constraints, or responsibility constraints. The downstream interface gating unit 180 controls one or more of a presentation interface 181, a workflow release interface 182, a machine-execution interface 183, a reviewer interface 184, an audit interface 185, an application-programming interface 186, or an export interface 187.

### 2. Operationalized AI Output

In the present specification, an operationalized AI output refers to an AI-assisted output that is in a state suitable for downstream operational handling, including presentation, review, release into a workflow, execution consideration, audit submission, export, or another form of technical use. The operationalized AI output is distinguished from an exploration-phase candidate that is still being generated, deferred, reevaluated, queued, restored, or selectively resumed. The present invention is directed to governance after generation and before downstream commitment.

### 3. Output-Bound Governance Descriptor

The governance descriptor is a data structure or logically equivalent control object that aggregates conditions relevant to release-state governance for a specific operationalized AI output. The governance descriptor may include one or more recipient roles, one or more review purposes, one or more audit purposes, one or more risk indicators, one or more contextual descriptors, one or more policy bases, one or more boundary-condition indicators, one or more authority constraints, and one or more responsibility constraints. The governance descriptor is output-bound, meaning that it is associated with the same operationalized AI output to which release-state control is applied.

### 4. Intervention-Level Selection

The intervention-level selection unit 130 selects an intervention level specifying a degree of review or control associated with the operationalized AI output. Example intervention levels include no additional intervention, confirmation-required intervention, mandatory reviewer intervention, audit escalation intervention, restricted-operation intervention, and inhibited-operation intervention. The intervention level may be coupled to the selected release state. For example, a confirmation-required release state may imply a confirmation-required intervention level, while an audit-only release state may imply an audit escalation intervention level.

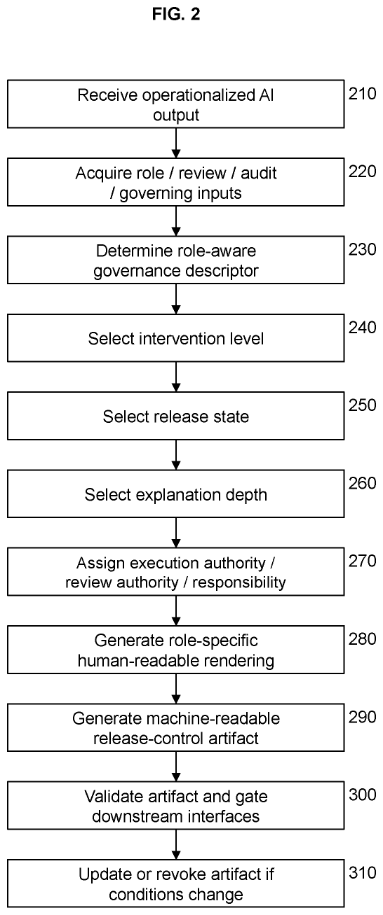

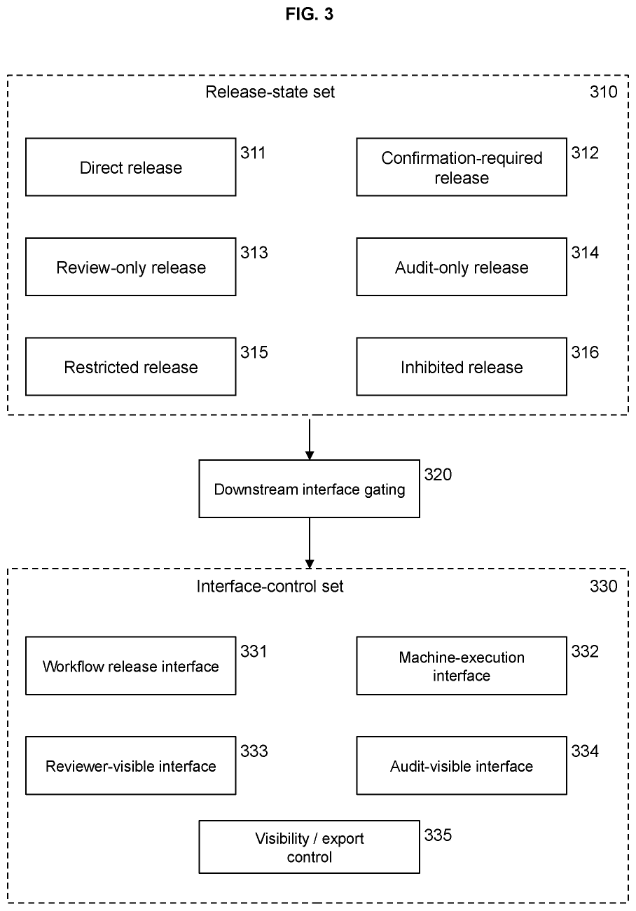

### 5. Release-State Selection (FIG. 2 and FIG. 3)

The release-state selection unit 140 selects a release state for the operationalized AI output from among a predefined set. In one example, the predefined set includes direct release, confirmation-required release, review-only release, audit-only release, restricted release, inhibited release, and conditional release. The direct-release state permits downstream release under the selected authority allocation. The confirmation-required state withholds downstream execution or export until a confirmation event is received. The review-only state exposes the output to a reviewer interface without enabling execution. The audit-only state exposes the output to an audit interface for compliance or traceability purposes. The restricted-release state allows release only to a constrained set of interfaces or recipients. The inhibited-release state prevents downstream release. The conditional-release state permits release only if additional conditions are later satisfied.

### 6. Explanation-Depth Selection and Multi-Render Explanation

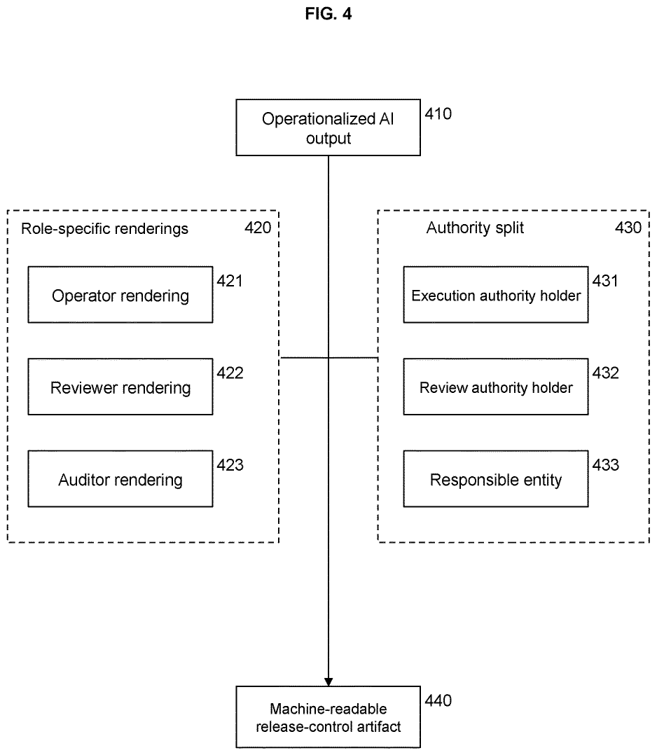

The explanation-depth selection unit 150 selects an explanation depth according to the governance descriptor, the intervention level, and the release state. Example explanation depths include a summary view, a rationale view, an evidence-linked view, an audit view, and a responsibility-oriented view. A role-specific human-readable rendering is then generated. For example, an operator may receive a summary plus release-state view, a reviewer may receive a rationale plus uncertainty or evidence-linked view, and an auditor may receive an audit or responsibility-oriented view associated with the same operationalized AI output. 7. Separation of Authority and Responsibility (FIG. 4)

The authority and responsibility assignment unit 160 independently assigns an execution authority holder and a review authority holder, and identifies at least one responsible entity. In some embodiments, an approval responsibility, an execution responsibility, a review responsibility, and an audit responsibility are separately recorded. This separation allows a same operationalized AI output to be executable only for a first authority holder, reviewable only by a second authority holder, and attributable to one or more responsibility subjects without requiring that these entities be identical.

### 8. Machine-Readable Release-Control Artifact

The release-control artifact generation unit 170 generates a machine-readable artifact associated with the same operationalized AI output. The artifact may include one or more release-state tokens, signed tokens, integrity-check values, workflow-release identifiers, execution-enablement signals, review-visibility flags, audit-visibility flags, or metadata encoding at least one of authority, review, release-state, intervention-level, and responsibility information. The artifact may be stored as metadata, a control object, a digitally signed token, a workflow identifier, a database record, or another machine-readable structure. The artifact is not merely a log record; rather, it is used by downstream gating logic to allow, withhold, restrict, export, or revoke access or execution capabilities.

### 9. Artifact Validation and Downstream Interface Gating

The downstream interface gating unit 180 validates the release-control artifact before enabling, restricting, or exposing a downstream interface. In one example, a workflow release interface 182 remains disabled until a valid artifact indicates direct release or confirmation-required release and any required confirmation condition is satisfied. In another example, a machine-execution interface 183 remains disabled until an execution-enablement signal encoded in the artifact is validated. In another example, a reviewer interface 184 or audit interface 185 is selectively enabled according to review-only or audit-only release states. Gating may additionally include user-interface gating, application-programming-interface gating, execution-path gating, recipient-specific routing, visibility control, operability control, or exportability control.

### 10. Revocation and Update

The revocation/update handling unit 190 may downgrade, revoke, reissue, or update a previously selected release state when a governing condition changes. For example, a policy update, a role update, a risk update, an audit event, a contextual change, an evidence update, or an authority instruction may cause generation of a replacement release-control artifact and a responsibility-reassignment record. Revocation or update may also trigger generation of a replacement human-readable rendering corresponding to the new release state or intervention level.

### 11. Domain Examples

In semiconductor and EDA support, an AI-assisted design recommendation, waiver recommendation, ECO recommendation, timing-closure recommendation, or signoff-preparation output may be governed so that a synthesis engineer receives a summary rendering under review-only release, a signoff owner receives an evidence-linked rendering under confirmation-required release, and an audit function receives an audit-oriented rendering under audit-only release. A machine-readable release-control artifact may prevent automatic flow insertion, report export, or signoff submission unless the assigned execution authority holder and the assigned review authority holder satisfy the release condition.

In software-development and AI-assisted coding support, an AI-generated patch recommendation, pull-request summary, test-remediation suggestion, or deployment-readiness output may be directly released to a developer sandbox, restricted for reviewer-visible release to a code owner, or inhibited for production release until a release engineer validates the associated artifact. Different explanation depths may be rendered for a developer, a security reviewer, and a release manager for the same operationalized AI output.

In cloud and infrastructure operations, an AI-assisted incident-action output, capacity-rebalancing output, rollback recommendation, or configuration-change recommendation may be governed so that an operator console receives a confirmation-required rendering, an SRE lead receives a responsibility-oriented rendering, and an audit console receives an audit-only rendering. The downstream interface gating may withhold an execution-enablement signal for an orchestration tool, a ticketing-system release, or an infrastructure API call until the release-control artifact is validated.

In cybersecurity operations, an AI-assisted alert triage output, containment recommendation, privilege-restriction recommendation, or threat-hunting output may be released in different states for different roles. For example, a SOC analyst may receive review-only release, an incident commander may receive confirmation-required release, and a compliance or forensic team may receive audit-only release, while direct automated containment remains blocked unless the artifact authorizes execution for the specified authority holder.

In enterprise decision support, an AI-assisted pricing recommendation, procurement recommendation, resource-allocation recommendation, or escalation recommendation may be selectively exposed so that a frontline operator sees a summary rendering under restricted release, a supervisor sees a rationale view under confirmation-required release, and an accountable approver sees a responsibility-oriented rendering with authority metadata before execution is permitted.

In legal and compliance support, an AI-assisted clause-risk output, policy-gap output, obligation-extraction output, or approval-readiness output may be role-aware governed such that a business user receives a summary rendering, counsel receives an evidence-linked or responsibility-oriented rendering, and an audit function receives an audit-only rendering. The release-control artifact may block export, external transmission, or contract-workflow insertion until the designated review authority holder approves the selected release state.

In healthcare-support workflows, an AI-assisted triage support output, care-path suggestion, documentation-support output, or utilization-review output may be governed so that a nurse receives a summary or restricted rendering, a physician reviewer receives a rationale or evidence-linked rendering under confirmation-required release, and a compliance officer receives an audit-only rendering. The invention is directed to post-output governance and does not require autonomous medical execution.

In industrial and manufacturing operations, an AI-assisted maintenance recommendation, spare-part allocation output, production-adjustment output, or anomaly-response output may be selectively set to direct release for a maintenance planner, confirmation-required release for a plant supervisor, review-only release for an engineering reviewer, or inhibited release when the artifact indicates that safety or responsibility conditions are not satisfied.

In robotics and ADAS-support workflows, an AI-assisted route-adjustment output, operating-parameter recommendation, scenario-review output, or post-event analysis output may be presented to a simulation reviewer under review-only release, to a fleet or test operator under confirmation-required release, and to a safety-governance function under audit-only release. The same output may therefore be visible, reviewable, auditable, or executable in different ways according to the assigned release state rather than according to a uniform approval workflow.

In public-sector or administrative support, an AI-assisted case-prioritization output, eligibility-assessment support output, response-drafting output, or evidence-organization output may be governed so that a case worker, a supervisor, and an audit authority each receive different renderings and release states, while downstream submission, external notice generation, or archival export is gated by the machine-readable release-control artifact.

These domain examples are illustrative and non-limiting. In each case, the invention is directed to post-output governance of a same operationalized AI output through role-aware release-state selection, explanation-depth selection, authority and responsibility separation, machine-readable artifact generation, and downstream interface gating, rather than to exploration-phase defer control, reevaluation priority, role reconfiguration, state restoration, or selective resume.

### 12. Distinction from Other Governance Layers

The present invention is directed to post-output governance and does not depend on exploration-phase defer control, safe exploration control, umbrella-level judgment placement architectures, reevaluation priority, escalation routing, broad role reconfiguration, restoration control, minimal-state restoration, or selective resume as a central mechanism. The invention instead centers on output-bound release-state governance through role-aware descriptor determination, intervention-level selection, explanation-depth selection, authority and responsibility split, machine-readable artifact generation, artifact validation, and downstream interface gating.

1. A computer-implemented method for role-aware release-state governance of an operationalized AI output in an information processing system, the method comprising:
receiving, by one or more processors, after generation by at least one artificial-intelligence processing component and before downstream operational commitment, the operationalized AI output;
determining, by the one or more processors, a role-aware governance descriptor for the operationalized AI output based on (i) a recipient role, (ii) a review purpose, (iii) an audit purpose, and (iv) at least one governing condition comprising risk information, contextual information, a policy constraint, a boundary condition, an authority constraint, or a responsibility constraint;
selecting, by the one or more processors, an intervention level, a release state, and an explanation depth for the operationalized AI output according to the role-aware governance descriptor;
independently assigning, by the one or more processors, an execution authority holder, a review authority holder, and at least one responsible entity;
generating, by the one or more processors, (i) a role-specific human-readable rendering of the operationalized AI output, and (ii) a machine-readable release-control artifact bound to the operationalized AI output and encoding at least the selected intervention level, the selected release state, and the assigned execution authority holder and review authority holder; and
controlling, by the one or more processors and according to validation of the machine-readable release-control artifact, at least one downstream interface so that the operationalized AI output is selectively set to direct release, confirmation-required release, review-only release, audit-only release, restricted release, or inhibited release.

2. The method of claim 1, wherein the role-aware governance descriptor further includes at least one of an intended-use context, a safety class, a regulatory class, a business criticality level, a policy basis, an uncertainty indicator, a contractual constraint, or an external-counterparty role.

3. The method of claim 1, wherein the intervention level is selected from among a plurality of intervention tiers that are coupled to the release state and include at least no additional intervention, confirmation-required intervention, mandatory reviewer intervention, audit escalation intervention, restricted-operation intervention, or inhibited-operation intervention.

4. The method of claim 1, wherein the explanation depth is selected from among a plurality of explanation tiers including a summary view, a rationale view, an evidence-linked view, an audit view, and a responsibility-oriented view.

5. The method of claim 1, wherein a plurality of role-specific human-readable renderings are generated for a same operationalized AI output for different recipient roles, reviewer roles, auditor roles, or responsible entities.

6. The method of claim 1, wherein the plurality of predefined release states includes direct release, confirmation-required release, review-only release, audit-only release, restricted release, inhibited release, and conditional release.

7. The method of claim 1, wherein the machine-readable release-control artifact comprises at least one of a release-state token, a signed token, an integrity-check value, a workflow-release identifier, an execution-enablement signal, a review-visibility flag, an audit-visibility flag, or metadata encoding at least one of authority, review, release-state, intervention-level, and responsibility information.

8. The method of claim 7, wherein the machine-readable release-control artifact is digitally associated with or cryptographically bound to the operationalized AI output and is verifiable before downstream release, execution, export, or interface exposure.

9. The method of claim 1, wherein controlling the at least one downstream interface includes at least one of user-interface gating, application-programming-interface gating, execution-path gating, recipient-specific routing, visibility control, operability control, or exportability control.

10. The method of claim 1, wherein controlling the at least one downstream interface includes withholding a workflow-release signal, an execution-enablement signal, or an export-enablement signal until the machine-readable release-control artifact is validated and a required confirmation condition is satisfied.

11. The method of claim 1, further comprising downgrading, revoking, reissuing, or updating the selected release state and generating a replacement machine-readable release-control artifact and a responsibility-reassignment record when at least one governing condition changes.

12. The method of claim 1, wherein the operationalized AI output is generated in at least one of semiconductor-design support, electronic-design-automation support, or AI-assisted engineering support, and is governed after generation and before downstream operational commitment.

13. The method of claim 1, wherein the operationalized AI output is generated in at least one of ADAS support, robotics support, enterprise decision support, operational monitoring support, or AI-assisted engineering support, and is governed after generation and before downstream operational commitment.

14. An information processing system configured to perform the method of claim 1.

15. A non-transitory computer-readable medium storing instructions that, when executed by one or more processors, cause the one or more processors to perform the method of claim 1.
